(19) United States
(12) Patent Application Publication
(10) Pub. No.: US 2013/0006877 A1
(43) Pub. Date: Jan. 3, 2013

(54) NANOSTRUCTURE TRACKING OF PRODUCTS

(75) Inventors: Bradford O. Brooks, Longmont, CO (US); Scott W. Pollyea, Loveland, CO (US); Srinivas B. Tummalapenta, Broomfield, CO (US); Hamza Yaswi, Louisville, CO (US)

(73) Assignee: International Business Machines Corporation, Armonk, NY (US)

(21) Appl. No.: 13/174,730

(22) Filed: Jun. 30, 2011

(51) Int. Cl. G06Q 10/00; G21K 5/00; B82Y 99/00

(52) U.S. Cl. 705/318; 705/333; 250/492.1; 977/943

(57) ABSTRACT

Some embodiments of the inventive subject matter are directed to incorporating a plurality of nanoparticles with a physical structure of an object. The object is transportable via locations associated with a chain of supply. Some embodiments are further directed to writing charges to modifiable portions of the plurality of nanoparticles incorporated with the physical structure of the object. Some embodiments are further directed to configuring the charges on the modifiable portions of the plurality of nanoparticles as data. The data describes one or more characteristics of the object and components of the object. The data is accessible via the locations associated with the chain of supply.

### BACKGROUND

Embodiments of the inventive subject matter generally relate to the fields of object tracking and authentication in a supply chain.

Today, almost every object intended for transport via a chain of supply (i.e., a product) requires a good deal of tracking procedure, from source to end. Exported products (i.e., products shipped across jurisdictional borders) often face strict scrutiny from the laws of the importing, or transferring, jurisdiction. For example, some transported products may contain or incorporate dangerous chemicals, conflict materials, ozone depleting compounds or other materials, that are banned, restricted or need to be declared, taxed or receive special permission for transport, and need to comply with specific shipping and handling procedures. Some product manufacturers include on their product packaging radio frequency identification (RFID) tags, bar codes, and so forth, which indicate something about the product contained within the package. However, such items are large, expensive, and often unreliable. Bar codes can be torn from packaging and/or forged. RFID tags can be disabled or lost. Further, currently many products, especially products that are sensitive, dangerous, prohibited, and so forth, and must be accompanied by a host of documentation, certifications, or assessments, which accompany the product and which must be performed on the product at various stages of the chain of supply. Such documentation and certifications can too be lost, forged, damaged, and so forth and assessments can be expensive and time consuming. Thus, currently, there are challenges associated with discovering and tracking details of a product through the chain of supply via bulky, and often unreliable, identifiers on the packaging and separate accompanying documentation, certifications, or assessments.

### SUMMARY

Some embodiments include a computer-implemented method for configuring an object for use in a chain of supply. The computer-implemented method is directed to incorporating a plurality of nanoparticles with a physical structure of the object. The object is transportable via locations associated with the chain of supply. In some embodiments, the method is further directed to writing charges to modifiable portions of the plurality of nanoparticles incorporated with the physical structure of the object. In some embodiments, the method is further directed to configuring the charges on the modifiable portions of the plurality of nanoparticles as data. The data describes characteristics of one or more of the object and components of the object. The data is accessible via the various locations associated with the chain of supply.

Some embodiments are directed to a system with a processing unit and a product tracking module. In some embodiments, the product tracking module is operable to, via the processing unit, read data stored on nanoparticles incorporated with one or more components of a product. In some embodiments, the product tracking module is further operable to determine from the data stored on the nanoparticles one or more characteristics of the one or more components. In some embodiments, the product tracking module is further operable generate checkpoint content for the product based on the data, wherein the checkpoint content is associated with an inspection of the product at a checkpoint in a chain of supply.

Some embodiments are directed to a system with a processing unit and a tracking unit. In some embodiments, the tracking unit is operable to, via the processing unit, read, at a point in a chain of supply, data stored on nanoparticles incorporated with a physical structure of a product. In some embodiments, the tracking unit is further operable to determine from the data stored on the nanoparticles one or more unique identifiers associated with the product. In some embodiments, the tracking unit is further operable to transmit a request for content about the product via a communications network, where the request includes the one or more identifiers.

Some embodiments are directed to a system with a processing unit and a nanostructure configuration unit. In some embodiments, the nanostructure configuration unit is operable to, via the processing unit, select nanoparticles affixed to a surface of a component. The component is included in a product at a first location associated with a chain of supply for the product. In some embodiments, the nanostructure configuration unit is further operable to generate charges on the nanoparticles. In some embodiments, the nanostructure configuration unit is further operable to determine unique identification data for the component and configure the charges to store the unique identification data for the component, where the unique identification data is configured for access via the nanoparticles at a second location in the chain of supply.

Some embodiments include a computer program product for configuring a component of a product for use in a chain of supply. The computer program product can include a computer readable storage medium having computer readable program code embodied therewith. The computer readable program code can be configured to detect data written to one or more nanoparticles incorporated with a physical structure of the component of the product at a first point in the chain of supply associated with the product. The data describes one or more characteristics of the component. The data is configured for access at one or more second points in the chain of supply. In some embodiments, the computer readable program code can further be configured to transmit the data to a data store, via a communications network, wherein the data is accessible from the data store via the communications network from the one or more second points in the chain of supply for evaluation against the data written to the nanoparticles.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of encoding, reading, and using data for a product in a chain of supply.

FIG. 2 is a flowchart depicting example operations for encoding nanoparticles affixed to a component of a product during manufacture, and configuring the component for subsequent reading and use during transit in a chain of supply.

FIG. 3 is an example conceptual diagram of affixing and encoding nanoparticles and processors to a component of a product at manufacture.

FIG. 4 is an example conceptual diagram of encoding and organizing data on nanoparticles into tiers for a component of a product.

FIG. 5 is a flowchart depicting example operations for reading, and using data from nanoparticles on a component of a product and generating checkpoint content based on the data.

FIG. 6A is an example conceptual diagram of passive data access from nanoparticles on a component of a product at a point in a chain of supply.

FIG. 6B is an example conceptual diagram of active data access from nanoparticles on a component of a product at a point in a chain of supply.

FIG. 7 is a flowchart depicting example operations for evaluating aggregate component data for product verification.

FIG. 8 is an example conceptual diagram of scanning a product and presenting content via a user interface.

FIG. 9 depicts an example computer system.

### DESCRIPTION OF EMBODIMENT(S)

The description that follows includes example systems, methods, techniques, instruction sequences, and computer program products that embody techniques of the present inventive subject matter. However, it is understood that the described embodiments may be practiced without these specific details. For instance, although examples refer to products in a chain of supply, distribution flow, and so forth, other instances may include non-consumer items or any other type of tangible and portable item or object that is subject to transit and/or tracking. Further, although some embodiments may refer to nanoparticles, or ultra-fine particles, (e.g., particles within one to one hundred nanometers in size), other embodiments can utilize particles of other sizes, such as fine particles or particles that are smaller than ultrafine particles. In other instances, well-known instruction instances, protocols, structures, and techniques have not been shown in detail in order not to obfuscate the description.

As mentioned previously, discovering and tracking details of a product through the chain of supply can be challenging, expensive, unsecure, and time consuming. Embodiments of the inventive subject matter, however, generate products with smart components. For example, embodiments include associating nanoparticles with a component of a product at a manufacturing source. Some embodiments can further include operations that add charge to the nanoparticles and can read or write data about the component using the charge. Some example operations can further include assigning levels, or tiers of data, to the nanoparticles of the components. Some example operations can further include assigning processors to each component (“component processors”). The processors can be related to categories, levels, etc. of components within the product. The component processors can be configured to transmit and/or receive data about the components, such as data related to product identifiers, relationship to other components, and so forth.

Further, at a checkpoint in a chain of supply, a scanner can scan the product. In one example, the scanner reads data directly from the nanoparticles. In another example, the scanner receives signals from component processors included on the components. In one example, the scanner focuses on a particular level of information stored via the nanoparticles. For instance, the scanner receives identifying information about a product identifier or a tier level. The scanner, at the checkpoint, transmits information to a universal database, such as verifications of authenticity of the components of the product, certifications of materials of the components, documentation for the product, and so forth, in response to the scanning of the nanoparticles. In some embodiments a secondary transmitter, such as one attached to a shipping container, communicates between nanoparticles and a scanner.

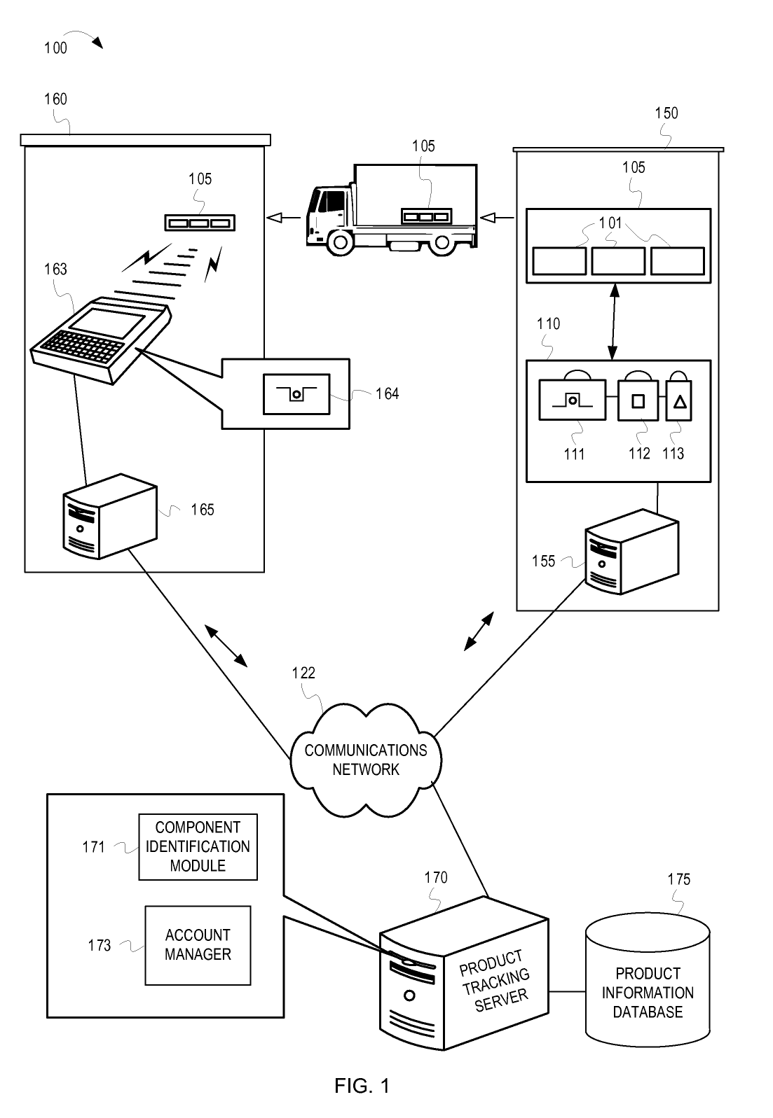

FIG. 1 is an example conceptual diagram of encoding, reading, and using data for a product in a chain of supply. In FIG. 1 a product tracking system (“system”) 100 includes a smart component fabricator 110 that configures components 101 of an object for transit and/or tracking in a chain of supply, such as a product 105. The smart component fabricator 110 includes a nanoparticle applicator 112, a component processor applicator 113, and an encoder 111. The nanoparticle applicator 112 affixes nanoparticles to the components 101. The encoder 111 writes data to the nanoparticles and/or one or more nanoprocessors on the components 101. The data describes information about the components 101, the product 105, a manufacturing process, or any other aspect related to the product 105 (e.g., origins of components 101, origins of subcomponents of the components 101, destinations of the components 101, subcomponents, the assembled product 105, etc.) in a chain of supply. In some embodiments, the component processor applicator 113 affixes a very small processor (e.g., a microprocessor, a nanoprocessor, etc.) that reads data from the nanoparticles and/or transmits signals that contain the data. For example, the component processor applicator 113 attaches a processor as similarly described for affixing (e.g., embedding, coating, etc.) nanoparticles on a component. The system 100 also includes a server 155 associated with a manufacturing facility 150. The server 155 controls the smart component fabricator 110 and connects, via a communications network 122, to a product tracking server 170, also included in the system 100. In some embodiments, the server 155 requests and/or receives data generated and/or stored on the product tracking server 170 or a product information database 175, such as unique universal identifiers, generated via a component identification module 171. The encoder 111 writes the received data to the nanoparticles. In some embodiments, the server 155 communicates data (e.g., copies of data written to the nanoparticles) to the product tracking server 170 which the product tracking server 170 stores in the product information database 175. In some embodiments, the product tracking server 170 accesses an account manager 173 to control user accounts associated with various entities involved in the chain of supply, such as a manufacturing entity, a shipping entity, an exporting entity, an importing entity, an inspections entity, a vendor entity, a customer, etc. The user account subscribes to a service to generate different types of identifiers and provide, or receive, other data and/or other services.

Furthermore, the system 100 includes devices utilized to track the product 105 at a facility 160, associated with a point (“checkpoint”) in the chain of supply. At the facility 160, a scanner 163 scans the product 105. The scanner 163 reads data and/or requests data from the nanoparticles and/or component processors on the components 101 of the product 105. The scanner 163 includes a decoder 164 to decode the data previously encoded via the encoder 111. A server 165 associated with the entity at the checkpoint, receives decoded data from the scanner 163 and generates content, (e.g., documentation, certifications, reports), for the product 105 in association with the checkpoint. In some embodiments, the server 165 also accesses the product tracking server 170, via an additional user account, and transmits the content for the checkpoint to the product tracking server 170 to store in the product information database 175. In turn, the product tracking server 170 subsequently provides the checkpoint content to the entity at the checkpoint as reports, and to other entities involved in the chain of supply.

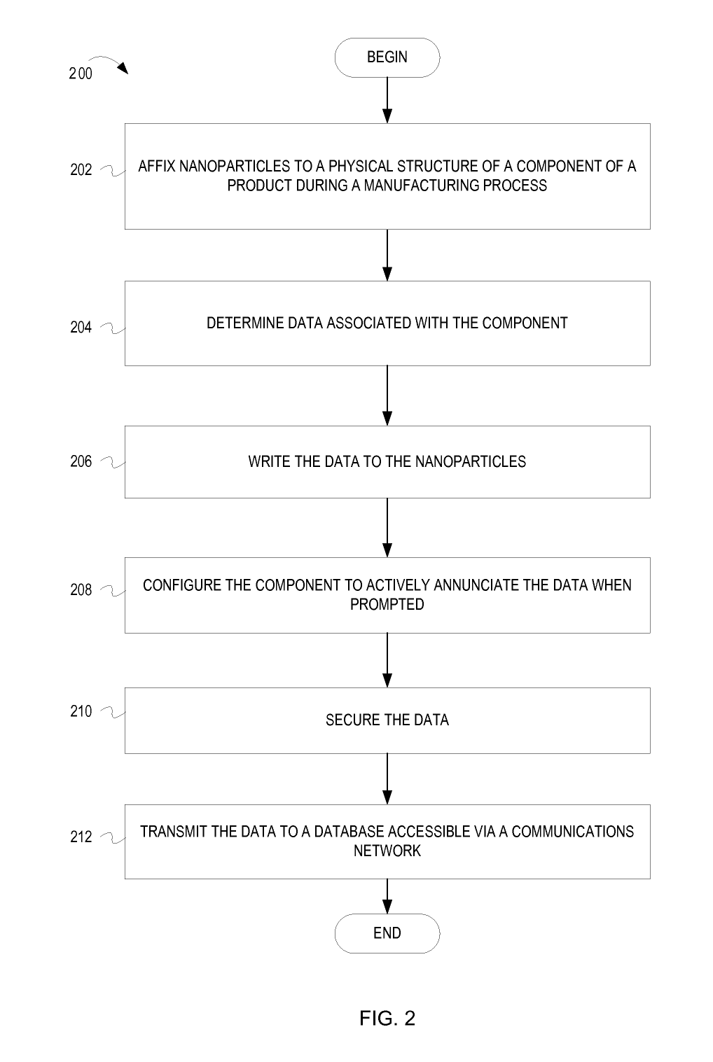

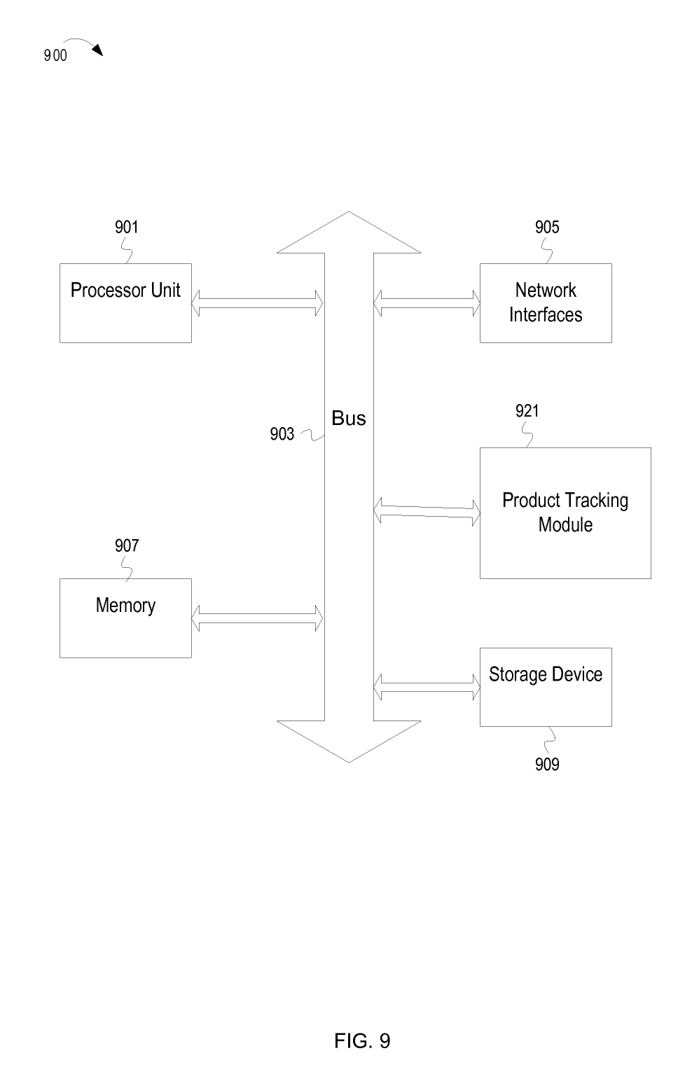

FIG. 2 is a flowchart depicting example operations for encoding nanoparticles affixed to a component of a product during manufacture, and configuring the component for subsequent reading and use during transit in a chain of supply. For illustration purposes, this disclosure describes operations associated with the blocks in FIG. 2 as being performed by a product tracking system (“system”). This system may, for example, include any or all of the elements described in FIG. 1 and/or FIG. 9.

FIG. 2 illustrates a flow 200 that the system performs.

Referring to FIG. 2, the system affixes nanoparticles to a physical structure of a component of a product during a manufacturing process (202). In some embodiments, the system embeds nanoparticles into a physical structure of a base material of the component. In another embodiment, the system coats the nanoparticles onto a surface of the component. In one embodiment, the system affixes the nanoparticles during or shortly after a standard manufacturing process. In other embodiment, the system affixes the nanoparticles after components have been manufactured and shipped to an entity that incorporates the components into a product. In some embodiments, the nanoparticles have a unique particle signature or specific makeup. For example, the nanoparticles originate from a manufacturing plant with a specific identifier or that has a material makeup that cannot be replicated or counterfeited.

Generally, nanoparticles include any particle that measures less than 100 nanometers. For embodiments of the inventive subject matter, however, the size of the nanoparticles may vary per unique functionality of a nanomaterial (e.g., thermal, electrical, magnetic, photonic). In some embodiments, particles of nanomaterials may be in the fine to ultrafine size range. An example of nanoparticles includes quantum dots, which are also known as nanocrystals (e.g., core-shell nanocrystals). Nanocrystals include an interface between different semiconductor materials. Quantum dots are nano-sized semiconductors that confine conduction band electrons, valence band holes, or excitons in all three spatial directions. Some embodiments make use of size, unique properties exhibited by nanomaterials, and other characteristics of nanoparticles and nanomaterials.

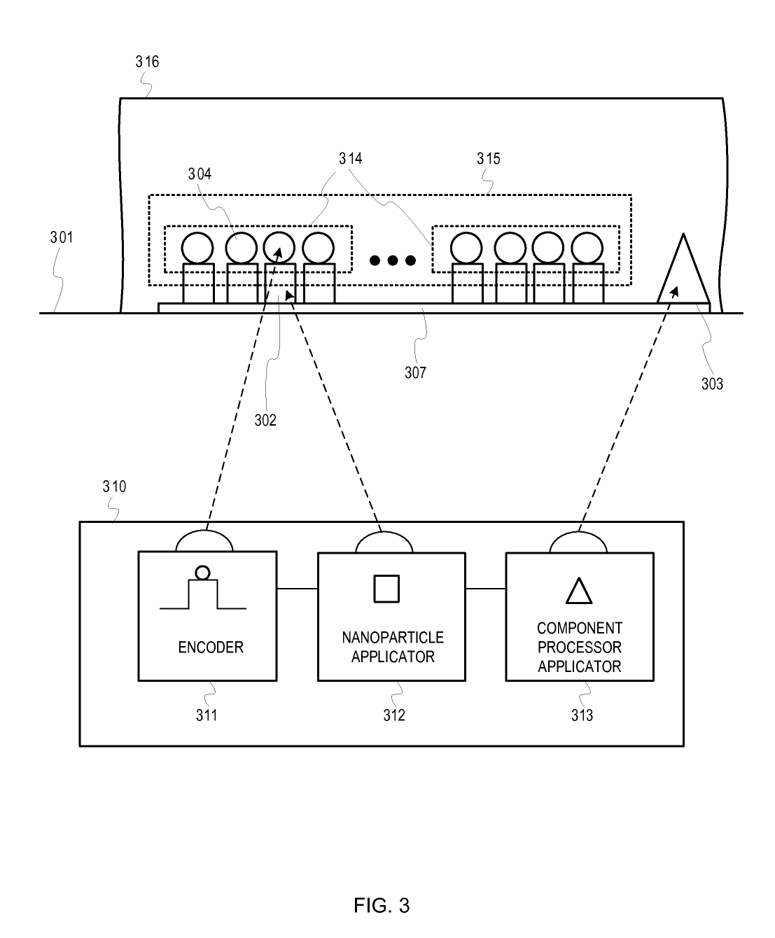

FIG. 3 is an example conceptual diagram of affixing and encoding nanoparticles and processors to a component of a product at manufacture. In FIG. 3, for example, a smart component fabricator 310 includes a nanoparticle applicator 312 and an encoder 311. The nanoparticle applicator 312 coats a surface of a component 301 with nanoparticles 302. The nanoparticles 302 receive charges 304. The charges can, for example, include electrical charges, photonic charges, and/or magnetic charges. The charges can be read from and/or written to by a machine. This disclosure will discuss FIG. 3 hereinafter.

Referring to FIG. 2, the system determines data associated with the component (204). In some embodiments, the data can be related to characteristics of, or associated, with assembly or manufacture of the product or component. For example, the data can be related to materials or a chemical makeup of the component (e.g., the data can include a Chemical Abstract Service, or CAS, number), dimensions or specifications of the component, origins of the component or origins of the materials of the component (e.g., country, state, manufacturing plant, batch, etc.), a purpose for the component, a date of manufacture of the component, a date of assembly into one or more other components of the product, an entity that manufactured or assembled the component, expiry data of the component, and subcomponents of the component. In some embodiments, the data can be related to transit of the product in a chain of supply and can include import/export data (e.g., product type, tariff item, etc.) stored as a Harmonized Commodity Description and Coding System number (HS or HTS) and/or as Schedule B number. The data can be country specific information, vendor specific information, or information specific to any other entity associated with the product, the chain of supply, etc.

In some embodiments, the information can be unique identifiers, such as, but not limited to, a product identifier (e.g., a unique, universal identifier for the product), a component identifier (e.g., unique, universal identifier for the component), an authenticity marker, a serial number, and a batch number. In some embodiments, the system can obtain unique identifiers from a central server. For example an entity (e.g., an entity that tracks data by multiple manufacturers of multiple components for the product) can provide a service that delivers and tracks identifiers for a variety of components, including one or more (or all) of the components of a product. The component identifiers can later be used as data signatures for components that can be used to verify completeness, authenticity, material composition, counterfeiting, etc. of a product while the product is in transit in the chain of supply.

For example, a first server associated with a point in the chain of supply sends information about the component to a second central server. An entity at the point in the chain of supply has an interest in the product. The first server provides information that identifies, for example, the entity, the product, and an account for the entity. The information may include a manufacturer's registered number, a product's registration number, account authentication data, passwords, and so forth. In some embodiments, the entity is a manufacturer and the manufacturer requests a component identifier that the manufacturer will use to affix to the nanoparticles of the component. The second server (e.g., a product tracking server), receives the request from the first server for the component identifier. The second server determines, from the request, a user account for a manufacturer of the component, and authorizes the user account to receive a component identifier. For example, the second server determines whether the manufacturer possesses a valid user account and has provided, via the request, proper credentials to access the service provided by the second server. The second server, for instance, looks up a manufacturer's registered number and determines account subscription settings for the user account that authorizes access to the service. The second server can also determine whether the component is registered, determine whether the manufacturer is authorized to make the component, and determine a type for the component. For instance, the component may be a type that is restricted, such as for use in a hazardous or dangerous product (e.g., a product with nuclear capabilities). The second server can thus generate a component identifier based on the account information (e.g., manufacturer's identifier, subscription settings, etc.). For instance, the second server can generate a component identifier, note the value for the component identifier in a database, and assign a type (e.g., open versus restricted) in the database. Thus, for subsequent requests to access a restricted component identifier, the subsequent requests would need to provide proper credentials to access the restricted component identifier. The second server can further associate the component identifier with a product as part of an aggregate, or collection, of combined component identifiers that, as a whole, constitute a product data signature. The product data signature uniquely identifies the product and its components. The second server, for example, evaluates the product data signature to determine authenticity and/or completeness of the product. The second server further reports the authenticity and/or completeness of a product within the chain of supply. In addition, the second server can keep track of how many times the component has been manufactured and the number of times information has been requested on the component. The second server can also keep track of an identity and location of a requesting entity and/or a manufacturing entity. The system, thus, may generate reports of how much of a product has been produced, imported/exported, recalled, and so forth.

Referring still to FIG. 2, the system writes the data to the nanoparticles (206). As mentioned previously, the nanoparticles may be quantum dots. In some embodiments, the system writes the data using a laser (e.g., a laser light beam specifically focused and/or tuned to modifiable portions of nanomaterial). In some embodiments, the system encrypts and/or write the data to portions of the nanoparticles that are alterable electrically, magnetically, or photonically (e.g., the system uses a laser to modify electrical properties of nanoparticles, imprint photosensitive nanoparticles, and/or alter magnetic properties of nanoparticles). The charges represent the data related to the component. The system subsequently accesses and reads the charges. The system writes different degrees of information depending on specific properties of the nanoparticles and their specific materials (e.g., a number of nanoparticles affixed to a component, a size of the nanoparticles, a size of the component, and so forth). For example, a quibit (an entanglement of quantum dots) that is 320 nm can currently hold a unique identification number of 32 characters in length. The 32 character identification number, for example, represents a component identifier that can be cross-referenced against a database. The system writes a 320 nm quibit to known components of products. In some embodiments, the system also compresses and/or encrypts data written to the nanoparticles.

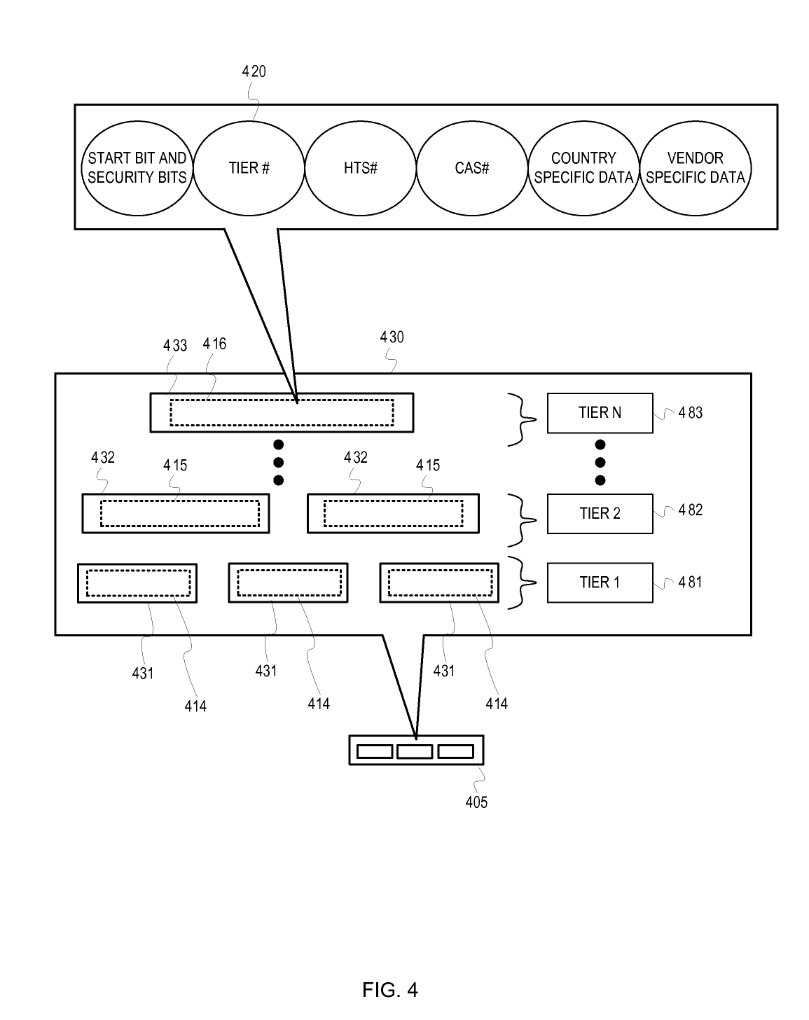

In some embodiments, the system organizes the data as code. The system encodes the data with a defined schema structure. The system can arrange charges on the nanoparticles into, for example, data values, data groupings, and data tiers. In some embodiments, the system categorizes the component data with a tier and assigns a tier identifier to the component data. The tier identifier identifies a relationship of the component to a level of assembly for the product or a structural category of the product (e.g., packaging may be a highest structural level, electronics may be a next level, substrate and wiring material may be a next level). FIG. 3 illustrates an example of writing charges to nanoparticles and organizing the charges into data. For example, in FIG. 3, the encoder 311 applies the charges 304 to the nanoparticles 302, which result in data bits 314. The encoder 311 aggregates the data bits 314 into component data 315. FIG. 4 illustrates an example of organizing data into tiers. In FIG. 4, the system organizes first component data 414 for first components 431 as a first tier of data 481, second component data 415 of second components 432 as a second tier of data, and so forth for different levels of components, to final component data 416 as a final tier of data 483 for a final component 433. The final data 416 includes, for example, a variety of information as described previously. Any of the first component data 414, the second component data 415, and the third final component data 415 can include a portion 420 of the final data 416, which indicates a tier number.

Referring back to FIG. 2, the system configures the component to actively annunciate the data when prompted (208). In some embodiments, the system can incorporate one or more very small processors (e.g., microprocessors, nanoprocessors, etc.) that mounts on a component. Such processors are small enough to be essentially undetectable by visible inspection. The very small processors, also referred to herein as “component processors,” can generate signals and receive signals that express, or annunciate, the data to each other and to external devices that query the component processors. The component processors can include transmitters and/or receivers, data stores, memory mechanisms, and logical computation units (e.g., to calculate values associated with subcomponents). Some components, which belong to a lowest tier or level for a product, may include fewer features, such as only a transmitter and not a receiver. The lowest tier component processors can communicate data about the lowest tier components to next tier component processors, such as to component processors of a next highest tier number in ascending order. The next tier component processors can aggregate data about their subcomponents and transmit that data to next higher tiered component processors, and so forth in a hierarchical manner. The highest tiered components(s), therefore, can include all data about lower tiered components, and requests for the data can be directed to the highest tiered component(s). FIG. 3 illustrates an example of a component processor 303 that connects to a substrate 307. The nanoparticles 302 connect to the substrate 307. Communication mechanisms, such as nanowires, nano-sized optical fibers, photonic interfaces, and the like, communicate data from the nanoparticles 302 to the component processor 303. In some embodiments, the nanoparticles 302 communicate with the component processor 303 wirelessly (e.g., via wireless signals or via near-field transmissions) instead of, or in addition to utilizing direct connections (e.g., nanowires, nano-sized optical fibers, photonic transmitters). The component processor 303 includes, for example, a transmitter, a receiver, a data store or memory, and a computational unit. The nanoparticles 302, substrate 307, and component processor 303 are covered with a material 316, for example, to protect nanostructures on the component 301.

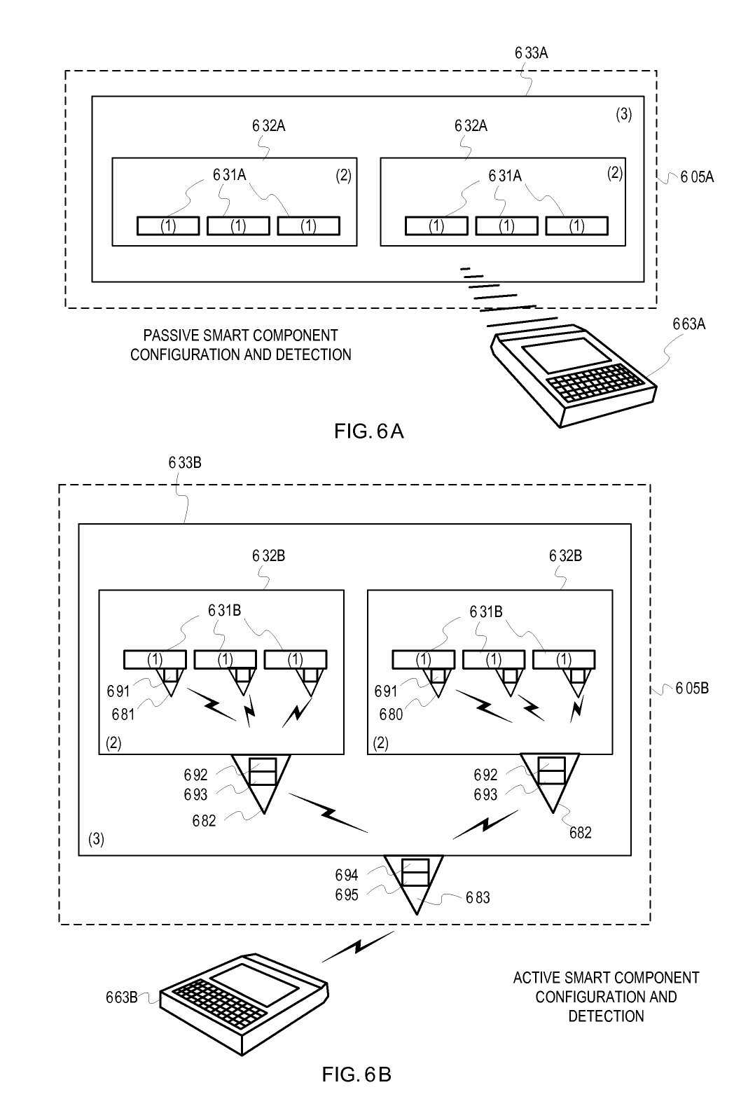

The system configures a component processor to understand and verify what data is being transmitted to it from a lower tiered component processor, and how many signals the component processor should expect for a number of subcomponents. Any tampering with the components, such as removal of certain authentic components and replacement with non-authentic components, would cause interruptions to internal communications between the component processors. Thus, when a scanner, for example, queries the highest tiered component processor at a checkpoint in a chain of supply if one of the lower tiered components had been removed, along with its component processor, then the internal chain of data communication within the product would fail. The scanner, thus, would detect a lack of data or some other error. The scanner, therefore, would, for example, interpret the lack of data, or other error as an indication of incompleteness and/or as a lack of authenticity of the product. Some component processors can further process data for respective components in advance before the product is queried. FIG. 6, described further below, provides some examples.

Referring back to FIG. 2, the system secures the data (210). For example, in some embodiments, the system makes the charges written to the nanoparticles as read-only data. In other embodiments, the system encrypts the data on the nanoparticles.

Referring still to FIG. 2, the system transmits the data to a database accessible via a communications network (212). In some embodiments, the system transmits unique identifiers included in the data that may be necessary to access data from the components during checkpoints in the chain of supply. A device at the checkpoint, such as a scanner, reads the data to determine whether product contains all of the unique identifiers. Each of the unique identifiers (and other data) of each of the components are parts of a unique whole. In other words, individual bits of data written to the nanoparticles, for any given type of component, collectively make up a unique ensemble or collection for the type of component. Component identifiers can be written to the nanoparticles. The combined component identifiers for the components make up a unique product signature. An apt analogy may be that each of the component identifiers represent individual musical “notes” that, when played represent a “chord” of data that uniquely identifies the product. The system records the component identifiers in a universal database, and relates them to the product, throughout the manufacturing process of the product. The storage of the component identifiers in the database is analogous to a composer writing musical notes into a chord on a score. The recorded totality of the individual component identifiers for the components represents the unique product signature. In some embodiments, the system can record component identifiers on component processors and configure the component processors to transmit the component identifiers. When, at a later point in the chain of supply, all relevant component identifiers are read in their entirety and/or as component processors broadcast in their entirety all component identifiers, the product, analogously plays all of the musical notes in a data chord. A device (e.g., a configured scanner at a checkpoint in the chain of supply) that reads, or measures, the data chord can recognize whether the chord is equivalent to the data chord that was written throughout the manufacturing process. If the measured data chord is different from the recorded data chord in any way, the device recognizes the difference and indicates that the product is incomplete, not authentic, modified, unsecure, etc.

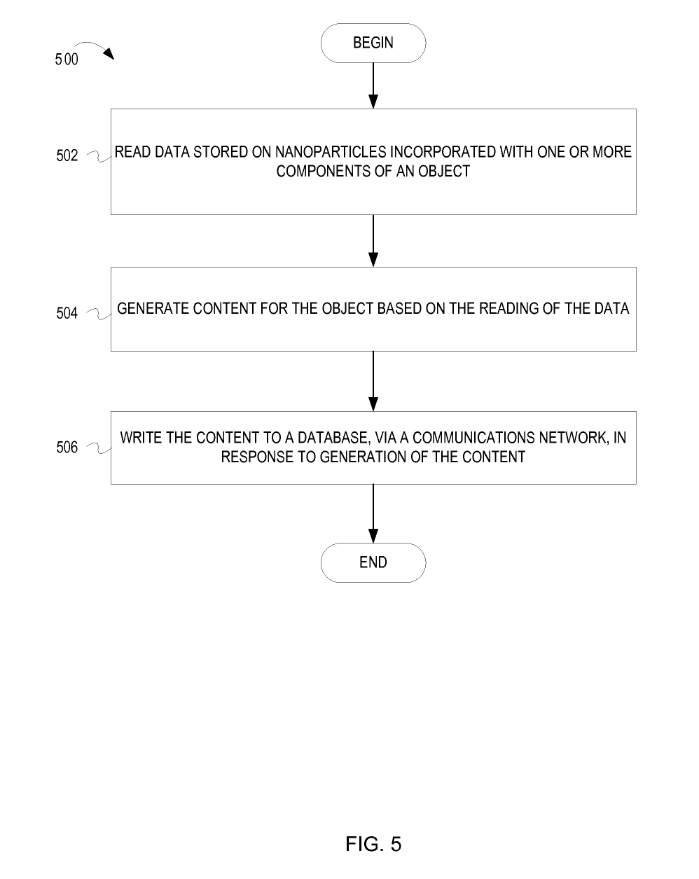

FIG. 5 is a flowchart depicting example operations for reading and using data from nanoparticles on a component of an object and generating content based on the data. For illustration, this disclosure will describe operations associated with the blocks in FIG. 5 as being performed by a product tracking system (“system”), which may, for example, include any or all of the elements described in FIG. 1 and/or FIG. 9. FIG. 5 illustrates a flow 500 that the system performs.

Referring to FIG. 5, the system reads data stored on nanoparticles incorporated with one or more components of an object (502). In some embodiments, the object is a product in a chain of supply and the system reads the data at a checkpoint in the chain of supply. In some embodiments, the content is related to the checkpoint and, therefore, may be referred to as checkpoint content. The object may be any object that is tangible and portable. The object may be subject to tracking (e.g., tracking via a commercial supply chain, tracking via a non-commercial supply chain, tracking security tags on items, tracking personal property, tracking items associated with people or pets, and so forth). The system focuses on a particular electronic description of the data, such as a tier of information or one or more (or all) individual bits of information stored via the nanoparticles. In some embodiments, the system reads all levels of information simultaneously from each coded grouping for each component. In some embodiments, the system reads data directly from nanoparticles (e.g., reads the code from the charge on individual nanoparticles). In some embodiments, the system reads signals generated and transmitted from a component processor incorporated onto the component.

FIG. 6A is an example conceptual diagram of passive data access from nanoparticles on a component of a product at a point in a chain of supply. FIG. 6B is an example conceptual diagram of active data access from nanoparticles on a component of a product at a point in a chain of supply. In FIG. 6A, a scanner 663A scans data from a product 605A which includes first components 631A, included in second components 632A, which in turn are included in a third component 633A. For illustrative purposes, FIG. 6A depicts tier values of components via parenthetical notations (e.g., the first components 631A are of tier “(1)”, the second components 632A are of tier “(2)” and the third component 633A is of tier “(3)”). The scanner 663A reads directly from charges on nanoparticles affixed to the components of the product 605A. The detection by the scanner 663A of data for the components of the product 605A may be referred to as a passive data detect as the product does not actively generate signals or push the data to the scanner 663A. On the other hand, in some embodiments, as shown in FIG. 6B, a scanner 663B scans data actively from a product 605B. For example, the product 605B includes first components 631B, included in second components 632B, which in turn are included in a third component 633B. FIG. 6B depicts tier values of the components via parenthetical notations (e.g., the first components 631B are of tier “(1)”, the second components 632B are of tier “(2)” and the third component 633B is of tier “(3)”). The first components 631B include first component processors 681 with transmitters 691 to broadcast data about the first components 631B to second component processors 682 associated with the second components 632B. The second components processors 682 include receivers 692 and transmitters 693. The receivers 692 receive signals transmitted via the transmitters 691. The transmitters 693 transmit signals to a third component processor 683. The third component processor 683 includes a receiver 694 and a transmitter 695. The receiver 694 receives signals from the transmitters 693. The transmitter 695 communicates with the scanner 663B. The scanner 663B does not directly read data from charges on nanoparticles of the components of the product 605B. Rather, the scanner 663B provides a signal to the third component processor 683 affixed to the highest level component, the third component 633B. When activated by the scanner 663B, the third component processor 683 provides a signal back to the scanner 663B that specifies information regarding the third component 633B, the second components 632B, and the first components 631B. The third component processor 683 knows data about the second components 632B and the first components 631B because the first component processors 681 broadcast data about the first components 631B to the second component processors 682. The second component processors 682 then broadcast their data (which includes information about the first components 631B) to the third component processor 683. In some embodiments, the first component processors 681 and the second component processors 682 broadcast their data to their receiving counterparts (i.e., to the next tiered components) in response to a request by the scanner 663B. In other embodiments, however, the first component processors 681 and the second component processors 682 broadcast their data prior to the request by the scanner 663B (e.g., during assembly, during transit, periodically).

Referring back to FIG. 5, the system generates content for the object based on the reading of the data (504). In some embodiments, the content includes certifications about the object, such as certifications that certain chemicals are not present due to enforcement of bans or restrictions on certain materials or chemicals in the object. In some embodiments, the content includes a bill of materials that describes the identities and masses of the materials of the components of the object. Other examples of content may include, but are not limited to, a bill of lading, an airway bill, a carrier's certificate, a commercial invoice, an entry manifest, a packing list, a vendor address, and a product price.

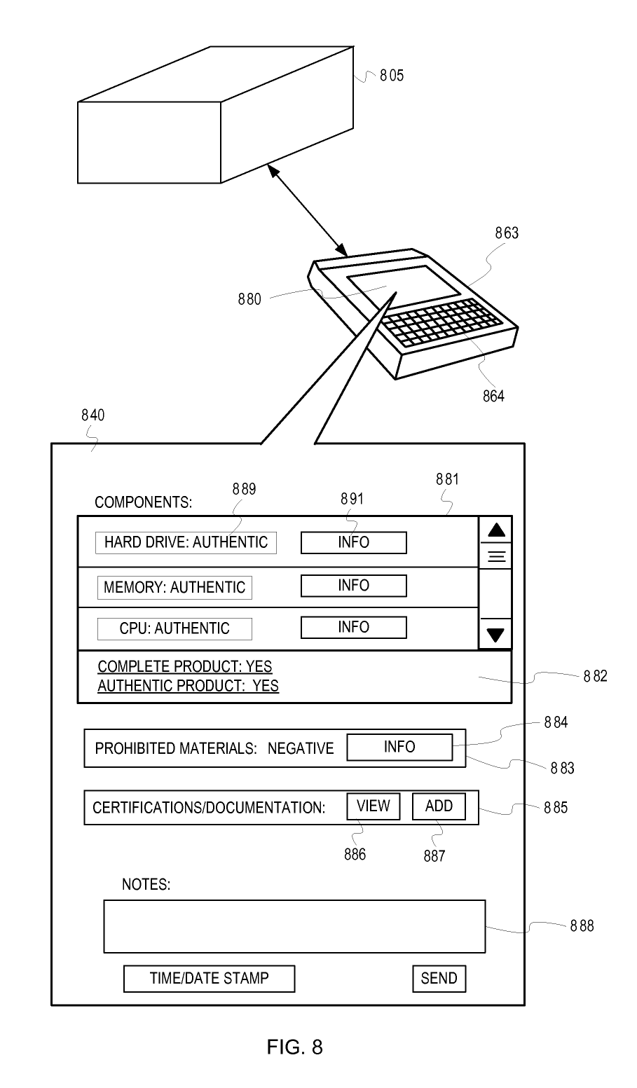

Referring to FIG. 5, the system writes the content to a database, via a communications network, in response to generation of the content (506). For example, FIG. 8 is an example conceptual diagram of scanning a product and presenting content via a user interface. In FIG. 8, a scanner 863 scans a product 805. The scanner 863 detects data about the product 805, including data regarding any internal components, by reading the data from nanoparticles and/or by receiving signals from component processors. The scanner 863, for example, receives information about the product 805 by accessing a product tracking server associated with the product 805 (e.g., by reading identifiers associated with the product 805 or components of the product 805, and requesting, via a communications network, information from the product tracking server). The scanner 863 includes a display 880 and an input mechanism (e.g., a keyboard 864, a touch screen, etc.). The scanner 863 also includes scanning mechanisms for scanning nanostructures, such as for reading charge. The scanner 863, in some embodiments, includes mechanisms for interfacing with component processors and for receiving and sending signals to the component processors. The scanner 863 presents, via the display 880, a graphical user interface (“user interface”) 840. The user interface 840 presents information and generates content. For example, the user interface 840 indicates a control 891 associated with individual components and/or component types or tiers in the product 805. The control 891, when activated via user input (e.g., touch screen input), displays data about the component as similarly specified above (e.g., materials, origin, identifiers, specifications). The user interface 840 also presents reports of analysis of components. For example, a section 883 indicates whether the scanner 863 found certain materials or types of materials in the product 805. The scanner 863 analyzes data specific to requirements (e.g., laws, jurisdictional rules, procedures, etc.) associated with a specific checkpoint in a chain of supply. One of the requirements may be to specify whether the scanner 863 finds specific materials in any of the components of the product 805 (e.g., hazardous materials, types of metals, etc.). For example, the scanner 863 may download modules via the Internet and install the modules while located at a checkpoint. In another example, a provider may install modules on the scanner 863 prior to providing the scanner 863 to an entity associated with a checkpoint. A control 884 specifies additional information about the materials. Further, a section 885 presents a control 886, that when activated, presents a view of past certifications, documentation, etc. associated with the product 805 via the chain of supply (e.g., from previous checkpoints). When user input or code activates the control 886, the scanner 863 communicates, for example, with a product tracking server via a communications network (or with a local machine that is subscribed to, and receives period updates of data from the product tracking server). The product tracking server, as similarly described in FIG. 1, contains information about the product 805 including past certifications and documentation related to the product 805 that were previously stored in a product information database accessible to the product tracking server. Furthermore, the user interface 840 includes a control 887 to add certifications and documentation related to the scan of the product 805 at the current checkpoint. For instance, as described above, the scanner 863 (or local counterpart machine) generates the documentation about existing or missing materials or chemicals that may be prohibited or of concern, indicate a bill of materials, indicate a time or date stamp, etc. A section 888 provides specific messages or notes about the checkpoint that an operator inputs into the scanner 863 and that the scanner 863 sends to the product tracking server for storage in the product information database.

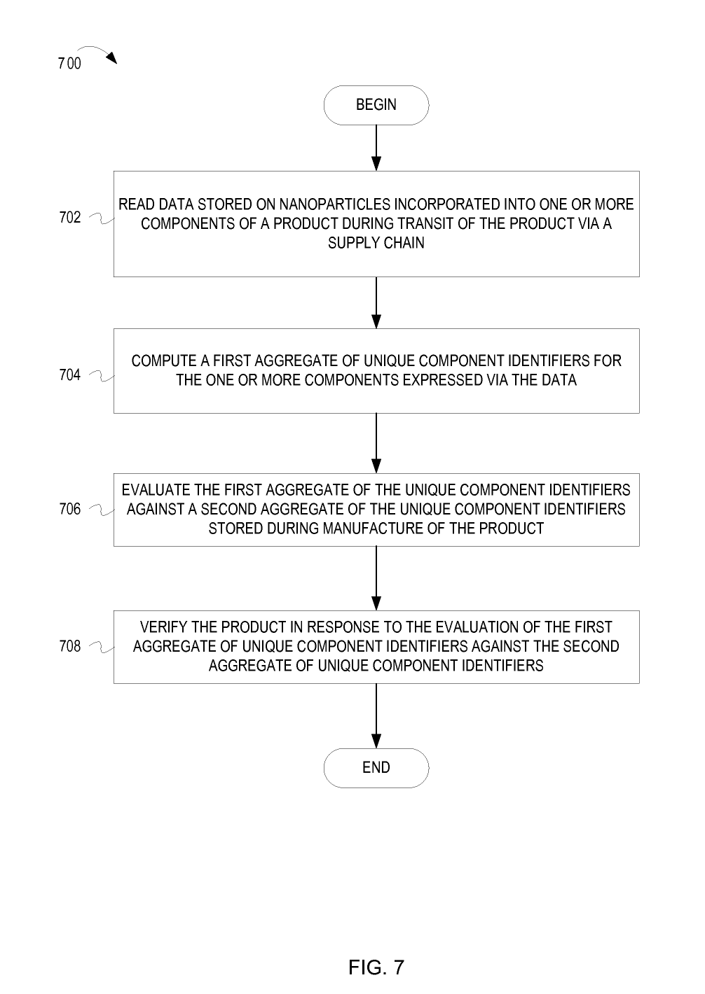

FIG. 7 is a flowchart depicting example operations for evaluating aggregate component data for product verification. For example purposes, operations associated with the blocks in FIG. 7 will be described as being performed by a product tracking system (“system”), which may, for example, include any or all of the elements described in FIG. 1 and/or FIG. 9. FIG. 7 illustrates a flow 700 that the system can perform.

Referring to FIG. 7, the system reads data stored on nanoparticles incorporated into one or more components of a product during transit of the product via a supply chain (702). For example, the system reads the data at a checkpoint in a chain of supply. In some embodiments, the system reads the data directly from charge on the nanoparticles. In other embodiments, the system requests the components to emit signals. A scanner, for example, emits a signal that activates and/or energizes component processors to emit their respective encoded data. According to the aforementioned musical analogy, the scanner requests the component processors to “play” (i.e., broadcast, transmit) their “musical notes” (i.e., their unique identifiers).

Referring to FIG. 7, the system computes a first aggregate of unique component identifiers for the one or more components expressed via the data (704). For example, when the scanner reads all the component identifiers, the system interprets the totality, or aggregate, of all the component identifiers as a measured product signature, or in other words, a combination of all component signatures in the product. Using the musical analogy, after reading all of the notes provided in the product the system recognizes a chord of data that describes the product that is being scanned.

Referring to FIG. 7, the system evaluates the first aggregate of the unique component identifiers against a second aggregate of the unique component identifiers stored during manufacture of the product (706). As described previously, during encoding processes for various components in a product, various manufacturers may have communicated with a centralized component cloud repository or product tracking server, and stored component identifiers in a database. The system may have further associated the component identifiers with a product identifier stored in the database. The totality of product identifiers and other data stored in the database represents a recorded product signature, or second aggregate of unique component identifiers.

Referring to FIG. 7, the system verifies the product in response to the evaluation of the first aggregate of unique component identifiers against the second aggregate of unique component identifiers (708). The system, for example, verifies authenticity and completeness of a product based on the evaluation. For example, referring again to FIG. 8, the scanner 863 performs or receives analysis of the components listed in section 881 and provides reports, such as an indicator 889 that specifies whether one or more components (e.g., hard drives, memory, chips), types of components, subcomponents, related components (e.g., software installed on hard drives) are authentic. A section 882 indicates whether the product 805 possesses all of the components that the product 805 is supposed to possess and that all of the components are authentic. For example, the scanner 863 accesses a database that indicates all of the component identifiers of the product 805, their relationships, their quantities, or other characteristics, which, together, represent the recorded product signature for the product 805. In some embodiments, the scanner 863 (or local machine associated with the scanner 863) provides security authorization information, such as passwords, encrypted keys, product registration numbers (attained from the nanoparticles incorporated with a physical structure of the components) in a communication to a product tracking server associated with the database. The scanner 863 receives authorization to read recorded component identifiers from the database via a communications network. In some examples where the component identifiers are not restricted, the server would not need to verify or authorize access to the product identifier. In other example, however, where the component identifiers are restricted, the server first authorizes access to the data on the database (e.g., the server checks credentials, subscription levels, etc.). The scanner 863 then receives recorded component identifiers via the communications network from the server. The scanner 863 (or local machine), in some embodiments, evaluates the component identifiers received from the server against component identifiers received via a scan of the product 805. The scanner 863 (or local machine) then verifies authenticity, completeness, secureness, and other characteristics of the components in response to the evaluation.

In an alternative embodiment, instead of the scanner 863 (or local machine) performing the evaluation, the server performs the evaluation. For instance, the server receives, via a communications network, the scanned component identifiers and receives a request to evaluate the scanned component identifiers with second component identifiers that were previously stored during a manufacture of the component. The system receives security authorization information to determine whether the requestor has rights to attain an evaluation. The server then evaluates the scanned component identifiers against the second component identifiers. If the evaluation indicates an exact match of all scanned component identifiers to the second component identifiers (e.g., in number, in value, etc.) the server can report to the scanner 863 a certificate of authenticity of the components.

In yet another embodiment, instead of the scanner 863 communicating directly with the server, the scanner 863 communicates with a local copy of component data stored on the scanner 863 or on a local machine associated with a checkpoint. Some, or all, portions of the local copy are encrypted, such as to restrict access to some product identifiers, or other product related data, based on whether the component types are restricted.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 9 depicts an example computer system 900. The computer system 900 includes a processor unit 901 (possibly including multiple processors, multiple cores, multiple nodes, and/or implementing multi-threading, etc.). The computer system 900 includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media or computer readable storage media. The computer system 900 also includes a bus 903 (e.g., PCI bus, ISA, PCI-Express bus, HyperTransport® bus, InfiniBand® bus, NuBus bus, etc.), a network interface 905 (e.g., an ATM interface, an Ethernet interface, a Frame Relay interface, SONET interface, wireless interface, etc.), and a storage device(s) 909 (e.g., optical storage, magnetic storage, etc.). The computer system 900 also includes a product tracking module 921. The product tracking module 921 can generate, track, and use data associated with a product in a chain of supply. Any one of these functionalities may be partially (or entirely) implemented in hardware and/or on the processing unit 901. For example, the functionality may be implemented with an application specific integrated circuit, in logic implemented in the processing unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901.

While the embodiments are described with reference to various implementations and exploitations, it will be understood that these embodiments are illustrative and that the scope of the inventive subject matter is not limited to them. In general, techniques for tracking data associated with a product in a chain of supply as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method for configuring an object for use in a chain of supply, comprising:
incorporating a plurality of nanoparticles with a physical structure of the object, wherein the object is transportable via locations associated with the chain of supply;
writing charges to modifiable portions of the plurality of nanoparticles incorporated with the physical structure of the object; and
configuring the charges on the modifiable portions of the plurality of nanoparticles as data, wherein the data describes one or more characteristics of one or more of the object and components of the object, and wherein the data is accessible via the locations associated with the chain of supply.

2. The computer-implemented method of claim 1, wherein the charges comprise one or more of electrical charge, photonic charge, and magnetic charge.

3. The computer-implemented method of claim 1, wherein the one or more of characteristics are associated with one or more of details of a manufacturing process for the object, materials of the object, and unique identifiers associated with the object.

4. The computer-implemented method of claim 1, further comprising:
configuring the data with a tier value, wherein the tier value represents a hierarchical relationship of one or more components of the object.

5. The computer-implemented method of claim 1 wherein the writing the charges comprises:
focusing one or more laser beams on the modifiable portions of the plurality of nanoparticles; and
generating the charges using the one or more laser beams.

6. The computer-implemented method of claim 1, wherein the incorporating of the plurality of the nanoparticles comprises one or more of embedding the nanoparticles into the physical structure of the object and coating the nanoparticles on a surface of the physical structure of the object.

7. The computer-implemented method of claim 1, wherein the incorporating the plurality of nanoparticles with the physical structure of the object is performed by a nanoparticle applicator, and wherein the writing of the charges and the configuring of the charges is performed by an encoder.

8. A system comprising:
a processing unit; and
a product tracking module operable to, via the processing unit,
read data stored on nanoparticles incorporated with one or more components of a product,
determine from the data stored on the nanoparticles one or more characteristics of the one or more components, and
generate checkpoint content for the product based on the data, wherein the checkpoint content is associated with an inspection of the product at a checkpoint in a chain of supply.

9. The system of claim 8, wherein the product tracking module is further operable to
evaluate the one or more characteristics against rules associated with a jurisdiction for the checkpoint; and
generate the checkpoint content based on evaluation of the one or more characteristics against the rules.

10. The system of claim 8, wherein the checkpoint content indicates a certification that certain chemicals are not present in the one or more components based on rules associated with a jurisdiction for the checkpoint.

11. The system of claim 8, wherein the checkpoint content indicates one or more of a bill of materials, a bill of lading, an airway bill, a carrier's certificate, a commercial invoice, an entry manifest, a packing list, a vendor location, and a price for the product.

12. The system of claim 8 further comprising:
one or more additional product tracking modules associated with the one or more additional checkpoints for the product in the chain of supply, wherein the one or more additional product tracking modules are configured to
read the data stored on the nanoparticles incorporated with the one or more components of the product, at the one or more additional checkpoints,
determine from the data stored on the nanoparticles one or more identifiers of the one or more components,
transmit the one or more identifiers via the communications network to a server, and
transmit a request to the server to provide the checkpoint content; and
a server configured to
receive the request,
use the one or more identifiers to access the checkpoint content, and
provide the checkpoint content via the communications network to the one or more additional product tracking modules associated with one or more additional checkpoints in response to the request.

13. A system comprising:
a processing unit; and
a tracking unit operable to, via the processing unit,
read, at a point in a chain of supply, data stored on nanoparticles incorporated with a physical structure of a product,
determine from the data stored on the nanoparticles one or more unique identifiers associated with the product, and
transmit a request for content about the product via a communications network, wherein the request includes the one or more identifiers.

14. The system of claim 13 further comprising:
a server configured to
receive the request,
use the one or more unique identifiers to access the content, and
provide the content via the communications network in response to the request.

15. The system of claim 14, wherein the server is configured to
detect, based on the one or more unique identifiers, that the content is restricted,
detect, via the request, security data for a user account associated with the point in the chain of supply, and
authorize the user account for access to the content based on the security data.

16. The system of claim 13, wherein the content was previously generated at one or more additional points in the chain of supply.

17. The system of claim 13 wherein the tracking unit is further configured to
receive the content,
generate additional content for the product based on one or more of the data and the content; and
transmit the additional content via the communications network for storage on a data store.

18. A system comprising:
a processing unit; and
a nanostructure configuration unit operable to, via the processing unit,
select nanoparticles affixed to a surface of a component, wherein the component is included in a product at a first location associated with a chain of supply for the product;
generate charges on the nanoparticles,
determine unique identification data for the component, and
configure the charges to store the unique identification data for the component, wherein the unique identification data is configured for access via the nanoparticles at a second location in the chain of supply.

19. The system of claim 18 further comprising:
a server associated with a third location in the chain of supply, the server configured to
generate the unique identification data, and
store the unique identification data in a database accessible from the second location.

20. The system of claim 19, wherein the nanostructure configuration unit is further operable to determine the unique identification data for the component being operable to
request the unique identification data from the server.

21. The system of claim 18, wherein the nanostructure configuration unit is further operable to configure the charges to store one or more details associated with a one or more of a manufacturing process for the product and origins of one or more the materials of the component.

22. The system of claim 18, wherein the nanostructure configuration unit is further operable to configure the charges to store a tier value, wherein the tier value represents a hierarchical relationship of the component to one or more additional components of the product, wherein the tier value is accessible at the second location to categorize a type of the component based on the tier value.

23. A computer program product for configuring a component of a product for use in a chain of supply, the computer program product comprising:
a computer readable storage medium having computer readable program code embodied therewith, the computer readable program code comprising computer readable program code configured to,
detect data written to one or more nanoparticles incorporated with a physical structure of the component of the product at a first point in the chain of supply associated with the product, wherein the data describes one or more characteristics of the component and wherein the data is configured for access at one or more second points in the chain of supply; and
transmit the data to a data store, via a communications network, wherein the data is accessible from the data store via the communications network from the one or more second points in the chain of supply for evaluation against the data written to the nanoparticles.

24. The computer program product of claim 23, said computer readable program code being further configured to:
write charges to the nanoparticles; and
configure the charges as data bits of the data.

25. The computer program product of claim 23, wherein the one or more of characteristics are associated with one or more of details of a manufacturing process for the product, materials of the component, and one or more unique identifiers associated with the component.

26. The computer program product of claim 23, wherein the nanoparticles have a unique data signature, and wherein the unique data signature of the nanoparticles is discoverable at the one or more second points in the chain of supply to determine one or more of veracity and authentication of the product.
